(19) United States
(12) Patent Application Publication
(10) Pub. No.: US 2023/0405663 A1
(43) Pub. Date: Dec. 21, 2023

(54) PROCESSING APPARATUS

(71) Applicant: TOYOTA JIDOSHA KABUSHIKI KAISHA, Aichi-ken (JP)

(72) Inventors: Akihiro TOKUYAMA, Toyota-shi (JP); Tomohiro SATO, Tajimi-shi (JP); Masato ISOBE, Nisshin-shi (JP); Hironari ADACHI, Toyota-shi (JP)

(21) Appl. No.: 18/337,042

(22) Filed: Jun. 19, 2023

(30) Foreign Application Priority Data
Jun. 20, 2022 (JP) 2022-098697

(51) Int. Cl. B21F 1/00

(52) U.S. Cl. CPC B21F 1/004

(57) ABSTRACT

To provide a processing apparatus for a flat wire adapted to suppress adhesion of a shaft and improve durability. A processing apparatus includes: a holder including a rotation axis for rotating in a bending direction of a flat wire; and a clamp including the rotation axis for rotating in the bending direction and configured to restrain the flat wire by clamping it with the holder, in which the clamp includes: a flange that restrains the flat wire between it and the holder; a shaft connected to the flange and disposed so as to pass through a penetrating hole formed in the holder; and a coating film formed on a surface of the shaft, and in which a hardness of the shaft and a hardness of the coating film are greater than a hardness of the holder.

### CROSS REFERENCE TO RELATED APPLICATIONS

This application is based upon and claims the benefit of priority from Japanese patent application No. 2022-098697, filed on Jun. 20, 2022, the disclosure of which is incorporated herein in its entirety by reference.

### BACKGROUND

The present disclosure relates to a processing apparatus for processing, for example, a flat wire.

Japanese Unexamined Patent Application Publication No. 2008-228435 discloses a processing apparatus for bending a flat wire.

### SUMMARY

It is known that by clamping a flat wire with a clamp shaft and a holder, a coating film can be formed on a shaft in a processing apparatus for bending a flat wire. Since the hardness of the holder is greater than the hardness of the shaft or the hardness of the coating film, when the holder is slid, the shaft and the holder may be adhered to each other causing deterioration in the processing apparatus. Therefore, there is a demand for a processing apparatus with excellent durability.

The present disclosure has been made to solve the problem mentioned above and an object of the present disclosure is to provide a processing apparatus adapted to suppress adhesion of a shaft.

According to an aspect of the present disclosure, a processing apparatus includes:
a holder including a rotation axis for rotating in a bending direction of a flat wire; and
a clamp including the rotation axis for rotating in the bending direction and configured to restrain the flat wire by clamping it with the holder,
in which the clamp includes:
   a flange that restrains the flat wire between it and the holder;
   a shaft connected to the flange and disposed so as to pass through a penetrating hole formed in the holder; and
   a coating film formed on a surface of the shaft,
in which a hardness of the shaft and a hardness of the coating film are greater than a hardness of the holder.

In the aforementioned processing apparatus, the hardness of the coating film may be greater than the hardness of the shaft.

In the aforementioned processing apparatus, the shaft may include a fitting part that slides within the penetrating hole and a supporting part that protrudes from the penetrating hole, and the coating film is formed on the fitting part.

According to the present disclosure, a processing apparatus adapted to suppress adhesion of a shaft and can be provided.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view illustrating a processing apparatus according to an embodiment:

FIG. 2A is a perspective view illustrating a holder of a processing apparatus according to an embodiment;

FIG. 2B is a perspective view illustrating a clamp of a processing apparatus according to an embodiment;

FIG. 3 is a cross-sectional view illustrating a shaft and a coating film formed on the shaft fitted into a penetrating hole of a holder in a processing apparatus according to an embodiment;

FIG. 4A is a diagram illustrating an operation of a processing apparatus 1 according to an embodiment, showing placement of a flat wire;

FIG. 4B is a diagram illustrating an operation of the processing apparatus 1 according to an embodiment, showing clamping and bending of a flat wire;

FIG. 4C is a diagram illustrating an operation of the processing apparatus 1 according to an embodiment, showing unclamping of a flat wire;

FIG. 5 is a top view illustrating a coil according to an embodiment;

FIG. 6A is a cross-sectional view illustrating a shaft and a coating film formed on the shaft fitted into a penetrating hole of a holder in a processing apparatus according to a comparative example, showing a state in which the coating film has worn out; and

FIG. 6B is a cross-sectional view illustrating a shaft and a coating film formed on a shaft fitted into a penetrating hole of a holder in a processing apparatus according to a comparative example, showing a state in which the coating film has come off from the shaft.

### DESCRIPTION OF EMBODIMENTS

Hereinbelow, specific configurations according to the embodiments will be described with reference to the drawings. The description given below shows suitable embodiments of the present disclosure and the present disclosure is not to be limited to these embodiments given below. Further, not all of the components/structures described in the embodiments are necessarily indispensable as means for solving the problem. Note that the following description and the attached drawings are appropriately shortened and simplified where appropriate to clarify the explanation. In the drawings, the identical reference symbols denote identical structural elements and the redundant explanations thereof are omitted.

### Embodiments

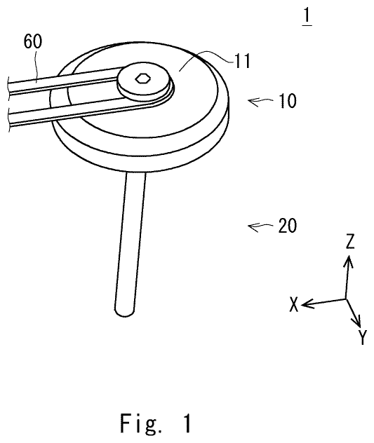

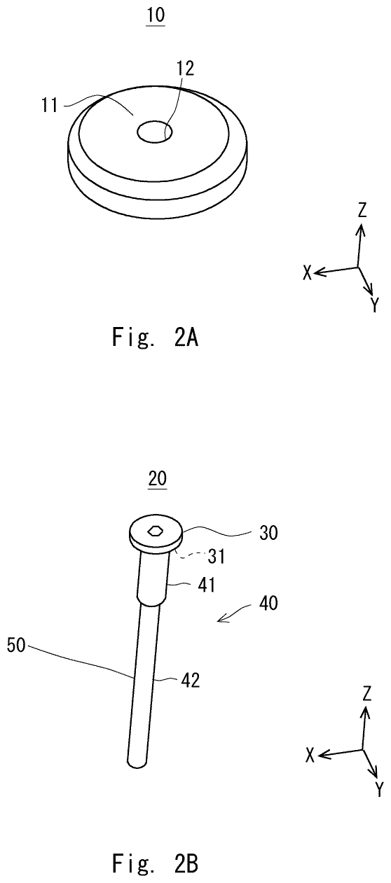

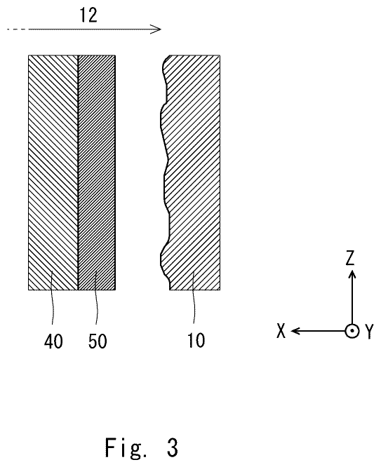

A processing apparatus according to an embodiment will be described. FIG. 1 is a perspective view illustrating a processing apparatus according to an embodiment. FIG. 2 is a perspective view illustrating a holder and a clamp of a processing apparatus according to an embodiment, in which FIG. 2A shows the holder and FIG. 2B shows the clamp. FIG. 3 is a cross-sectional view illustrating a shaft and a coating film formed on the shaft fitted into a penetrating hole of a holder in a processing apparatus according to an embodiment. As shown in FIGS. 1 to 3, the processing apparatus 1 includes a holder 10 and a clamp 20. The processing apparatus 1 performs, for example, bending processing of bending a lead wire of a coil such as a flat wire 60.

Here, for the sake of simplifying the explanation of the processing apparatus 1, an XYZ orthogonal coordinate system is employed. For example, the Z-axis direction defines the vertical direction of the processing apparatus, the direction in the Z-axis positive side defining the upper side of the processing apparatus and the direction in the Z-axis negative side defining the lower side of the processing apparatus. Further, the XY-plane represents the horizontal plane. As noted above, the XYZ orthogonal coordinate system is employed only for the sake of simplifying the explanation of the processing apparatus, and thus the actual orientation of the processing apparatus 1 is not limited to the orientation shown in the drawings.

The holder 10 has, for example, a disk-like shape. The holder 10 includes, on the upper surface thereof, a planar holder surface 11. Note that the shape of the holder 10 may not be limited to a disk-like shape and may be any shape such as a plate-like shape or a hemispherical shape as long as the holder 10 includes the holder surface 11. The holder 10 has a penetrating hole 12 formed on the holder surface 11, the penetrating hole 12 penetrating through the holder 10. The holder surface 11 may, therefore, be annular with the penetrating hole 12 formed in the center thereof. The central axis of the penetrating hole 12 extends in the Z-axis direction.

The clamp 20 includes a flange 30 and a shaft 40. The flange 30 and the shaft 40 may be integrally formed. The flange 30 has, for example, a disk-like shape. The flange 30 includes, on the bottom surface thereof, a planar flange surface 31. Note that the shape of the flange 30 is not limited to a disk-like shape and may be any shape such as a plate-like shape or a hemispherical shape as long as the flange 30 has the flange surface 31.

The shaft 40 has, for example, a round-bar shape. One end of the shaft 40 is connected to the flange surface 31 of the flange 30. The shaft 40 is perpendicular to the flange surface 31. The flange surface 31 may, therefore, have an annular shape with the shaft 40 connected to the center thereof. The central axis of the shaft 40 extends in the Z-axis direction.

The shaft 40 includes a fitting part 41 and a support part 42. The fitting part 41 is connected to the support part 42. The fitting part 41 is provided on one end part of the shaft 40, that is, a part of the shaft 40 on the Z-axis positive side. The supporting shaft 42 is a part of the shaft 40 on the Z-axis positive side. The fitting part 41 slides within the penetrating hole 12. The supporting part 42 protrudes from the penetrating hole 12. The fitting part 41 has a diameter larger than a diameter of the supporting part 42.

The shaft 40 is disposed so at to pass through the penetrating hole 12 formed in the holder 10. The fitting part 41 of the shaft 40 is, for example, fitted into the penetrating hole 12. The flange surface 31 and the holder surface 11 face each other. The flat wire 60 is placed between the flange surface 31 and the holder surface 11. The shaft 40 moves in the Z-axis direction with respect to the holder 10. The shaft 40 moves in the Z-axis direction in such a way that the distance between the flange surface 31 and the holder surface 11 is varied. In this case, the fitting part 41 slides in the Z-axis direction within the penetrating hole 12.

Further, the shaft 40 rotates about the rotation axis with respect to the holder 10. In this case, the fitting part 41 slides in the direction in which it rotates about the rotation axis within the penetrating hole 12. The holder 10 and the clamp 20 may rotate about the rotation axis in an integral manner.

The surface of the shaft 40 may be coated with a coating film 50. Therefore, the clamp 20 may further include, in addition to the flange 30 and the shaft 40, the coating film 50 formed on the surface of the shaft 40. The coating film 50 may be formed on the entire surface of the shaft 40 and not on the surface of the flange 30, or may be formed on the entire surface of the clamp 20 including the surfaces of the flange 30 and the shaft 40. Further, the coating film 50 may be formed only on the surfaces of the fitting part 41 of the shaft 40 and not on the surface of the supporting part 42 of the shaft 40. The coating film 50 can be formed only on the parts of the shaft 40 that where it is necessary to form this film on, whereby it is possible to reduce the cost for the materials, the processing time, and the like.

The hardness of the shaft 40 and the hardness of the coating film 50 are greater than the hardness of the holder 10. Further, the hardness of the coating film 50 may be greater than the hardness of the shaft 40. The relationship between the hardness of the coating film 50, the shaft 40, and the holder 10 will be described later, giving comparative examples.

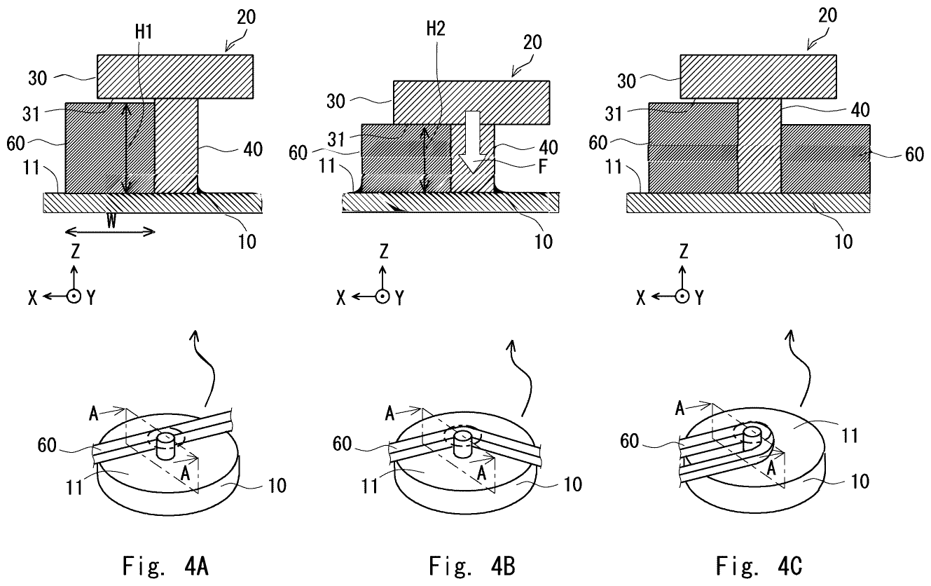

Next, the operation of the processing apparatus 1 will be described. FIG. 4 shows diagrams illustrating operations of a processing apparatus 1 according to an embodiment, in which FIG. 4A illustrates placement of the flat wire 60, FIG. 4B illustrates clamping and bending of the flat wire and FIG. 4C illustrates unclamping of the flat wire 60. The drawings at the top of FIGS. 4A, 4B, and 4C each shows a cross-section of the drawing shown at the bottom of the respective figures as seen in the A-A plane.

As shown in FIG. 4A, the flat wire 60 is placed in the processing apparatus 1. Specifically, the flat wire 60 is passed through between the flange surface 31 of the flange 30 and the holder surface 11 of the holder 10. The height H of the flat wire 60 before it is bent is, for example, a height H1. The width W of the flat wire 60 before it is bent is, for example, a width W1. The height H of the flat wire 60 is defined by the length of the flat wire 60 on the holder surface 11 in the Z-axis direction. The width W of the flat wire 60 is defined by the length of the flat wire 60 on the holder surface 11 in the horizontal direction.

Next, as shown in FIG. 4B, a force F is applied to the clamp 20 in the Z-axis negative direction. Accordingly, the flat wire 60 is clamped between the flange surface 31 and the holder surface 11. As described above, the clamp 20 restrains the flat wire 60 by clamping it between the flange 30 and the holder 10. Specifically, the flange 30 restrains the flat wire 60 between it and the holder 10. At this timing, the shaft 40 slides in the Z-axis negative direction within the penetrating hole 12 so as to clamp the flat wire 60. The height H of the flat wire 60 that has been clamped may change to, for example, a height H2. The height H2 of the flat wire 60 is smaller than the height H1. Next, the holder 10 and the clamp 20 rotate about the rotation axis while the flat wire 60 is clamped between the flange surface 31 and the holder surface 11. Accordingly, the processing apparatus 1 bends the flat wire 60 around the rotation axis. As described above, the holder 10 and the clamp 20 have a rotation axis for rotating in a bending direction of the flat wire 60. Therefore, the holder 10 and the clamp 20 are rotatable in the bending direction of the flat wire 60.

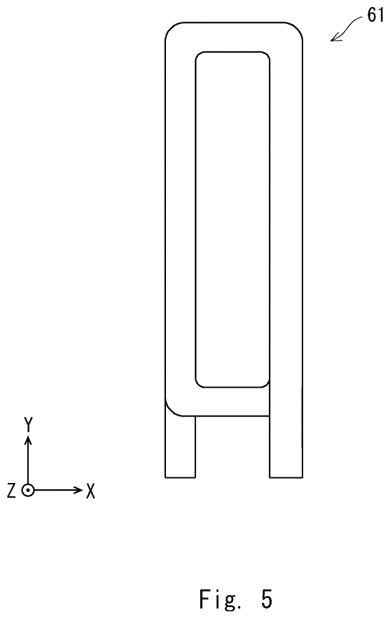

Next, as shown in FIG. 4C, the clamp 20 is moved in the Z-axis positive direction. By this configuration, the processing apparatus 1 unclamps the flat wire 60. Then, the processing apparatus 1 sends out the next part of the flat wire 60 to be bending processed between the holder surface 11 and the flange surface 31. The processing apparatus 1 repeats the bending processing of the flat wire 60 by repeating the aforementioned operation. FIG. 5 is a top view illustrating a coil according to an embodiment. A coil 61 shown in FIG. 5 is formed by the processing apparatus 1 repeating the bending processing of the flat wire and laminating the wire spirally in the vertical direction.

Next, before describing the effects of the present embodiment, a processing apparatus according to a comparative example will be described. Then, the effects of the present disclosure will be described by comparing them with those of the comparative examples.

In a processing apparatus such as a winding machine that is an equipment for producing the coil 61 and the like from the flat wire 60, high-speed sliding is required to improve productivity. When machine oil is adhered to the coil 61 for smooth high-speed sliding, there may be an adverse effect on the coil 61 at a later stage of the processing. Therefore, the processing apparatus described above does not use any machine oil. Therefore, as an anti-adhesion measure for the shaft 40 that slides at a high speed in a non-lubricant manner without relying on the use of any machine oil, the coating film 50 of a low-friction coefficient (t) is formed on the surface of the shaft 40.

However, in the case where the durability of the coating film 50 is not insufficient, the coating film 50 falls off from the shaft. In such a case, metal-to-metal contact occurs between the sliding surfaces of the holder 10 and the shaft 40. This causes adhesion between the holder 10 and the shaft 40, damaging the processing apparatus. As a result, the durability of the processing apparatus lowers.

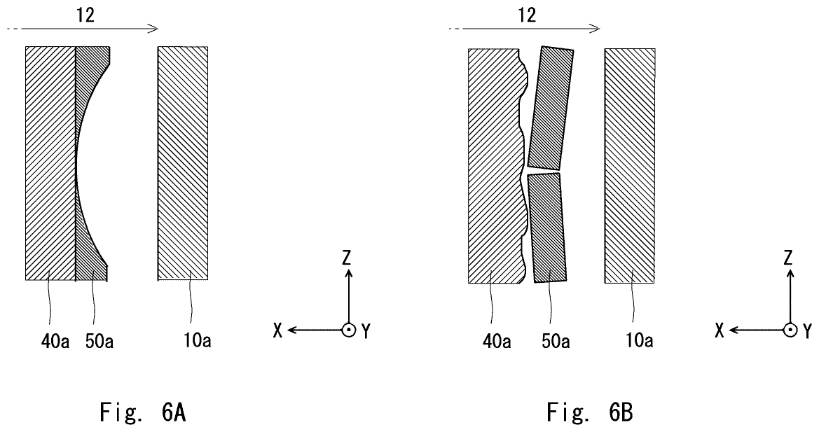

FIG. 6 shows cross-sectional diagrams illustrating a shaft and a coating film formed on the shaft fitted into a penetrating hole in a processing apparatus according to a comparative embodiment, in which FIG. 6A illustrates a case in which the coating film has worn out and FIG. 6B illustrates a case in which the coating film has come off from the shaft. As shown in FIGS. 6A and 6B, examples of the causes of adhesion that occurs between the holder 10a and the shaft 40a are the coating film being worn out and the coating film 50a coming off from the shaft Specifically, in the case where the hardness of the base material of the shaft 40a and the hardness of the coating film 50a are lower than the hardness of the holder 10a, adhesion occurs due to the coating film 50a of the shaft 40a being worn out or the coating film 50a coming off from the shaft 40a due to the sliding of the shaft 40a within the holder 10a causing metal-to-metal contact between the sliding surfaces of the holder 10a and the shaft 40a. In the case of the processing apparatus according to a comparative example, the relationship between the hardness of the holder 10a, the coating film 50a and the shaft 40a is expressed by the following Expression (1).

Hardness (holder)>Hardness (coating film)≥Hardness (shaft) (1)

This relationship can be applied to the relationship of the hardness of the structural components at a general processing point. That is, in the processing apparatus according to a comparative example, the hardness of a receiving component for receiving a sliding component (hereinafter referred to as a receiving component for a sliding component), such as the holder 10a and the like in which the sliding component slides, and the hardness of the components such as the coating film 50a, the coated components such as the shaft 40a, and the like are expressed by the following Expression (2).

Hardness (a receiving component for a sliding component)>Hardness (coating film)≥Hardness (coated component) (2)

Next, the effect of the present embodiment will be described. In the processing apparatus 1 according to the present embodiment, unlike the processing apparatus according to the comparative example, the hardness of the coating film 50 and the hardness of the shaft 40 are made greater than the hardness of the holder 10. That is, in the present embodiment, the relationship of the hardness of the coating film 50, the shaft 40, and the holder 10 is expressed by the following Expression (3).

Hardness (coating film)>Hardness (shaft)≥Hardness (holder) (3)

Accordingly, since the holder 10 deforms due to the sliding force, adhesion can be suppressed. This relationship can be applied to the relationship of the hardness of the structural components at a general processing point. That is, by generalizing the processing apparatus 1 according to the present embodiment, the relationship of the hardness of the coating film 50, the coated components such as the shaft 40, and the receiving component for a sliding component, such as the holder 10, may satisfy the following Expression (4).

Hardness (coating film)>Hardness (coated component)≥Hardness (receiving component for a sliding component) (4)

Further, as mentioned above, there are two possible causes of the adhesion between the holder and the shaft 40: the coating film wears out or the coating film comes off from the shaft, and adhesion caused by the coating film wearing out is of a more serious concern than the adhesion caused by the coating film coming off from the shaft. In particular, in the case where the sliding is a dominant movement, adhesion caused by the coating film wearing out is of a more serious concern than the adhesion caused by the coating film coming off from the shaft. Therefore, it is desirable to make the hardness of the coating film 50 greater than the hardness of the shaft 40. That is, it is desirable that the following Expressions (5) and (6) be satisfied.

Hardness (coating film)>Hardness (shaft) (5)

Hardness (coating film)>Hardness (coated component) (6)

The processing apparatus 1 according to the present embodiment can take a countermeasure as to the adhesion of a shaft thereby suppressing adhesion of the shaft and improving the durability of the processing apparatus.

Embodiments of the present disclosure have been described above but the present disclosure it not to be limited to the aforementioned embodiments and can be modified as appropriate without deviating from the object of the present disclosure. Further, the configurations of the embodiments can be combined as appropriate.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A processing apparatus comprising:
a holder including a rotation axis for rotating in a bending direction of a flat wire; and
a clamp including the rotation axis for rotating in the bending direction and configured to restrain the flat wire by clamping it with the holder,
wherein the clamp includes:
a flange that restrains the flat wire between it and the holder;
a shaft connected to the flange and disposed so as to pass through a penetrating hole formed in the holder; and
a coating film formed on a surface of the shaft,
wherein a hardness of the shaft and a hardness of the coating film are greater than a hardness of the holder.

2. The processing apparatus according to claim 1, wherein the hardness of the coating film is greater than the hardness of the shaft.

3. The processing apparatus according to claim 1, wherein
the shaft includes a fitting part that slides within the penetrating hole and a supporting part that protrudes from the penetrating hole, and
the coating film is formed on the fitting part.
